(19) United States
(12) Patent Application Publication
(10) Pub. No.: US 2025/0265659 A1
(43) Pub. Date: Aug. 21, 2025

(54) SYNTHETIC USER PROFILE MANAGEMENT

(71) Applicant: David Bianchi, Wimberley, TX (US)

(72) Inventor: David Bianchi, Wimberley, TX (US)

(21) Appl. No.: 19/056,418

(22) Filed: Feb. 18, 2025

Related U.S. Application Data
(60) Provisional application No. 63/555,835, filed on Feb. 20, 2024.

(51) Int. Cl. G06Q 50/00

(52) U.S. Cl. CPC G06Q 50/01

(57) ABSTRACT

A synthetic user profile is generated, representing a synthesized person based on a second person's preferences. The synthetic user profile is modified to improve engagement with the second person based on the second person's interaction with the synthesized person's profile. The synthetic user profile representing the synthesized person is maintained to remember past interaction with the second person between sessions of interaction.

### CLAIM OF PRIORITY

This application claims the benefit of priority to U.S. Provisional Application Ser. No. 63/555,835, titled “ARTIFICIAL INTELLIGENCE USER PROFILE MANAGEMENT,” filed on Feb. 20, 2024, and incorporated herein by reference in its entirety.

### FIELD

The field relates generally to online user profiles, and more specifically to synthetic user profile management.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

Computer devices interconnected via networks have evolved over time form simple standalone computers such as the traditional personal computer to smart set-top boxes, computerized smart home controllers, and smart phones having capabilities that rival the most complex computers of a generation ago. Modern smart phones often include large display screens, cameras, microphones and speakers, and a variety of other components that enable them to perform a wide variety of functions, such as web browsing, voice or video communication, Global Positioning System (GPS) navigation, and the like. Some applications or apps, such as social media apps, are specifically architected to allow users to interact with other users, such as to chat with others in an online community environment as well as to share pictures, videos, stories, and other such content.

Social interaction is now not only an in-person activity, but with growing advances in technology now includes video calls and group meetings, social interaction via services such as Facebook, Snapchat, and Twitter, and other such ways to interact with people or groups of interest. To participate, a user typically uses some authentication information such as an email address or phone number to make an account, and is then able to post content such as messages, photos, or videos and selectively make them available to others. The user may similarly view content created by others, such as viewing a news feed of content of people they follow or who are designated as friends. The user can manage their account by making some parts private, limiting who can see certain content, and the like, and other such actions as they post content.

But, social media still has significant limitations in that people may often feel reluctant to share their true self, or to participate at all. A person may wish to interact with someone who is unavailable, may wish to express themselves in different ways in different environments, or to present a version of themselves that they are continuing to understand and explore. A need therefore exists for improved social media interaction to address challenges such as these.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 is a block diagram of a networked system of computerized devices, as may be used to practice some embodiments.

FIG. 2 is a flow diagram showing user interaction with an artificial intelligence synthetic profile management system, consistent with an example embodiment.

FIG. 3 is a flow diagram of a method of interacting with an artificial intelligence (AI) profile, consistent with an example embodiment.

FIG. 4 shows a block diagram of a generative pretrained transformer, as may be used to practice some embodiments.

FIG. 5 shows a block diagram of a general-purpose computerized system, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

The rapid growth of social media applications on the Internet has provided users with the ability to engage with people and groups they might not otherwise be able to socialize with, as well as to keep in touch with friends and family who aren't able to spend a desired amount of time together in person. Social media users may find communities that are tailored to special or niche interests, such as gardening, scuba diving, or woodworking, and converse with others who share their passions. Similarly, groups of friends from school days may be able to keep in touch rather than lose track of each other, and provide support for each other as they pursue independent careers and families.

Social media is somewhat limited though in its ability to enable a person to express different sides of themselves, such as through different profiles or different versions of themselves presented to various social groups or communities. A person may wish to present a profile on a hobby forum such as a gardening page on a social media site that does not express their political, religious, or other interests, while fully embracing these interests in a community activism forum or social media platform.

Similarly, people may wish to interact with versions of other people, real or imagined, that are tailored to their particular interests, such as being able to engage with a grandparent regarding common interests but within various constraints. In some examples, such constraints may include avoiding certain subjects, understanding and adapting conversation to the person's age and maturity level over time, and being able to provide guidance or conversation when the grandparent is unable to reach a computer.

Some examples presented herein therefore provide for generating an artificial intelligence (AI) profile representing a person, and modifying or tailoring thee artificial intelligence profile to interact with one or more other users based on the other user's relationship with the person. The artificial intelligence profile representing the first person may be maintained based on their interaction with the one or more other users.

In another example, an artificial intelligence (AI) profile may be generated to represent a synthesized person based on a second person's preferences. The generated AI profile may be modified to improve engagement with the second person based on the second person's interaction with the synthesized person's artificial intelligence profile, and the AI profile may be maintained to such that the synthesized person remembers past interaction with the second person between sessions of interaction.

In a more detailed example, a service may be provided to enable a user to generate an AI profile representing themselves, another person, or a synthetic person, such as in the QRME example below:
QRME—Your source for sharing more of you and your personal AI generated version of yourself. Not to mention the capability of masking your identity with other possible AI avatar choices including your own custom built avatar, our community can be a trusted safe space to stash and share you to the world. Also users needing or wanting to anonymously share your innermost self can choose their desired avatar and personality. We do not discriminate based on religion, sex, or gender, and we welcome everyone seeking a truly mobile platform to share everything that is you.
Using a modern up-to-date questionnaire containing such questions as language, country, state, city, culture, race, ethnical background, identity, age and maturity, also choice of incorporate things like pictures videos responses to any particular friends, family and followers and outsourcing those from places like Facebook, Twitter, X, YouTube, etc. and incorporating your personal boundaries column. This the users will have access to, as well as adapt and update all new friends and followers even Moderating what they can see and have access to. Adapting to your change as you grow in age and maturity with friends, family, followers, companies in corporations, etc. along your life travels and “Beyond” (After death Engagement) Where you and or your moderator can designate who, what and for how long can see your profile. Example one: A great grandfather of an beloved granddaughter has had an account for many years, and has developed quite a stock of data. In-turn, this individual can get to know their great grandfather whom passed away at any given time and at that particular great granddaughters age, and maturity level, which user profile can adapt and moderate itself to react, specifically targeting that individuals age of maturity and any notes or directions left behind would prompt AI to use those commands from there loved one. Examples include: this individual had a nickname that he would call his great granddaughter And AI would use users data would incorporate it.
The user has no limitations to their personal generated responses, whether avatars would be executing commands of encouragement or sympathy, storytelling etc. Example two: Famous actor possibly from wild West films who might also have loved ones we have his stored as well. Taking into consideration his followers fans, friends, catering to them separately. This gentleman would respond a little differently to a fan. So users profile, changes content, and would come on screen in costumes using wardrobes and have personal engaging moment with these individuals. Friends might like to hear their dearly missed friend incorporating that separately, corporations might use this gentleman in commercial and supply crowdfunding for any loved ones, left behind or organizations for donations, wherever the proceeds might to up to the user. Examples like these are limitless you have full control of your own journal. And when you leave, you can leave it to set parameters or in good hands trusted, moderator or company organization.
Authentication; Users will then login with username and password or given an option to login via Facebook Google, Apple, facial recognition, etc. The system then verifies the user's identity and authorizes access to the platform's functions. The user interacts with the interface by discussing or inquiring about you, your favorite hobbies, on your favorite trail/places you've made it to. Things like your day, what you might've been thinking aspirations hopes dreams love by utilizing your personal journey log and your watch's daily log entry and trail taken. And get it all set into place for quick leave behind or commemorative sticker with QR code that can be posted anywhere on the go including websites, such as Facebook, X, OnlyFans, TikTok, YouTube, Twitch, etc. including businesses and or organizations etc. For some a little more discreet.
Adult content and website examples—fulfilling all your guilty pleasures, using AI to engineer what happens next such as things like swapping of items, their color, the users physiques the users, responsiveness taking things like commands and prompts, incorporating, VR, 2-D and 3-D, etc. Experiences and interactions tailored to your needs and wants to your favorite user profiles with AI guiding and assisting your next step of action or commands to your needs and wants, virtually audio, fulfilling your desires. Requiring passwords and approval if wanted or necessary; users may create content like posts, photos, videos, comments, groups, and events in and in addition to the marketplace, offering-goods and services, as well as posting or browsing on the news feed and interacting with others using articles and resources to show or drive your point across.
Helping us ensure you get the best experience with your community internationally with ease, we will be providing our chat engines, local events, and forums in all languages tailored to your needs. Incorporating your own bilingual avatars allowing users picking your avatar to recognize and communicate with ease to the followers across the world.

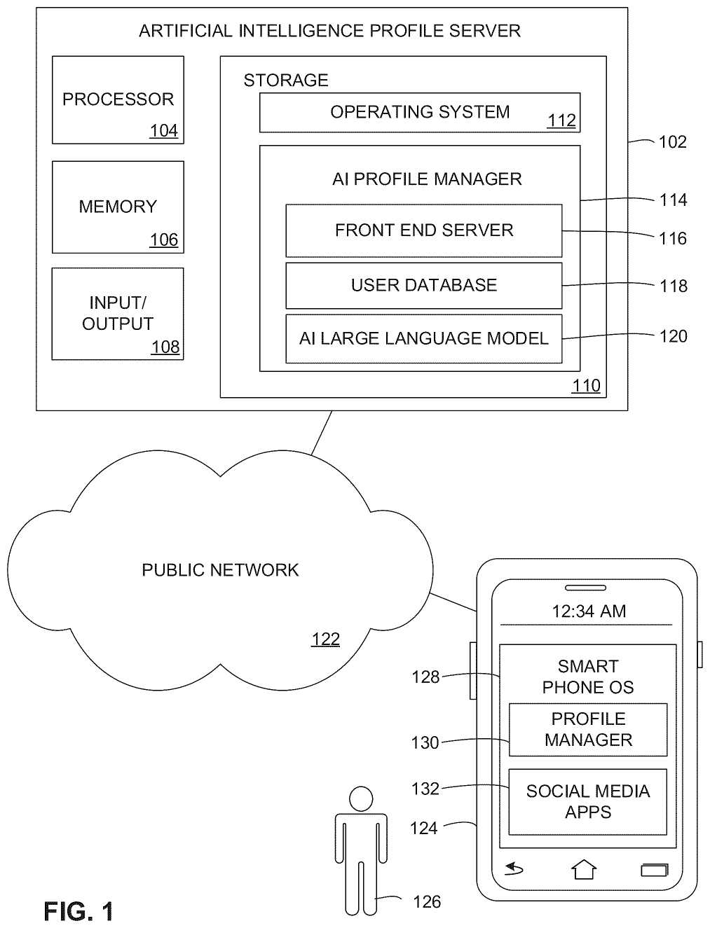

FIG. 1 is a block diagram of a networked system of computerized devices, as may be used to practice some embodiments. Here, an artificial intelligence (AI) profile server 102 comprises a processor 104, memory 106, input/output elements 108, and storage 110. Storage 110 includes an operating system 112 and AI profile manager 114 that is operable to generate and maintain a synthetic profile for a user such as via large language model artificial intelligence. The AI profile manager 114 in this example further comprises a front end server 116 operable to receive and service requests from client devices for AI profile creation, user registration or login, and the like. User database 118 comprises user information gathered from user registration, created and/or shared user content, and user information imported from other sources such as social media sites. AI large language model 120 is trained to engage with users as though it were a synthetic person or a modified AI version of a real person, such as to present different sides of a person's personality or interests in different environments, to enable a user to interact with a deceased relative or loved one, or to enable a user to interact with a historical figure, famous person, or the like.

The personal AP profile server 102 is coupled to a public network 122, such as the Internet, facilitating communication with one or more user devices such as smart phone 124 that user 126 may employ to interact with the AI profile server. Smart phone 124 in this example comprises a smart phone operating system (OS) operable to load and execute various applications such as profile manager 130 and social media apps 132. In operation, a user may initiate contact with the AI profile server 102 such as through installing an app, visiting a URL directing the user to a web page served at least in part by front end server 116, or through other suitable means. A new user is prompted to build a user profile that may be retained in user database 118, and may in a further example be used to train AI large language model 120, to train a user-specific version of the large language model, or to remember the state of prior user interactions with the AI large language model such that the large language model may provide personalized AI-generated user profiles of the user or others across multiple login sessions.

The user may employ profile manager 130, a web page, or other such mechanism to interact with AI profile server 102 to construct an AI profile. The profile in various examples may be based on the user, based on another person such as a friend or relative, based on a historic or public figure, or may be synthetic such as based on various interests or desires of the user creating the AI profile. The user may interact with the AI profile server via the server's front end server 116, establishing a user profile that may be stored in user database 118. This information may be used to generate a synthetic user profile using artificial intelligence, such as AI large language model 120 which in further examples may be a generative pretrained transformer, a recurrent neural network, or other such artificial intelligence technology.

The user may in some embodiments choose to make one or more profiles, choose to make the profile(s) anonymous or identifiable, and may elect to leave out or focus on certain elements of their personal user profile in creating the one or more synthetic AI profiles. In one such example, a user may wish to create one or more synthetic AI versions of themselves to share anonymously with others, to create a profile for their recently deceased grandfather to converse with, and to create a profile of a historic figure, celebrity, or other such subject to engage with. The created profiles in some examples are based on known characteristics of the subject that the synthetic profile may be attempting to mimic, such as by collecting the subject's writings, postings, videos, and other examples of the subject's personality, personal interactions, and demographics. Known history and interactions of the subject and demographic questions such as language, country, state, city, culture, race, ethnic background, beliefs, identity, age, and maturity level may be gathered to create the subject's AI profile, and in a further example may be changed, such as where a subject grows older and more mature, has varying interests over time, or the like.

Once an AI profile is created, the user may log in and manage the AI profile via AI profile server 102, such as by setting the user profile to engage in social media interaction with the user and/or with others, by interacting directly with the AI profile, by customizing or modifying the AI profile, and the like. A user interface may provide for interaction with the AI profile manager 114 to facilitate such interactions, and may provide for interaction with the synthetic AI user profile in a conversational manner via AI large language model 120. In a further example, information provided in generating an AI profile may be filtered or processed to remove bias and to comply with terms of service, such as removing racist, sexist, abusive, of other such elements from synthetic AI profiles and their interactions.

The synthetic AI profile in some examples may create content, such as for social interaction with other users, for social interaction with the AI profile owner, or for other purposes. The content in various examples may comprise photos, videos, comments, groups, events, posts, and the like, and in a further example may comprise a marketplace-type posting offering goods or services. The content may be posted publicly or retained privately, and may be included in a news feed of other user such as friends, members of the same group, members sharing an interest or problem with the creating user, etc., Created content may also be sent via chat, mail, personal message, group message, and the like to one or more other users or groups.

Content in some examples may be shared via social media, group chat, private chat, or other such means. In other examples, the interface between the created content and a user may be presented using other web services, software, and/or hardware, such as a conversation held via a Bluetooth device such as a headset. In other examples, the AI profile may be presented via a robotic device, a virtual reality or augmented reality interface such as VR googles or the like, or through other such means.

The AI profile manager 114 in a further example comprises data processing functionality operable to apply algorithms for content distribution, moderation, personalization, and the like, and may be flagged for further review for compliance with standards of participation and/or sharing with others. The processed content may be stored in user database 118, along with user profiles, posts, media, social graph data, third-party advertisements, and other such data. Processed content may be retrieved in operation by front end server 116 or other data processing elements to present content to each user based on their preferences, settings, applicable algorithms, and the like. Users may then interact with AI profile content, engage with other users, and record likes, shares, and messages or responses to the content.

AI profile server 102 in further examples comprises other functions such as backend services to handle friend requests, messaging, content delivery, and the like, and may include various security or privacy measures such as encryption, access control, and monitoring to provide a degree of user privacy and security. The AI profile manager may comprise various additional functions or algorithms in various embodiments, such as algorithms for content recommendation, sentiment analysis, user behavior prediction, real-time user monitoring, and the like, such as to improve AI profile interaction with individual users.

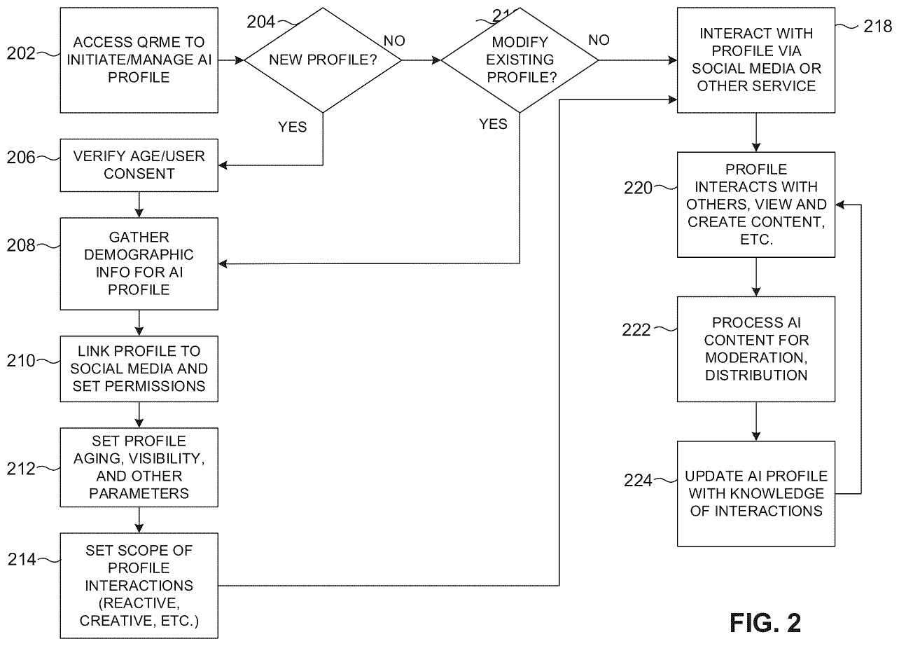

FIG. 2 is a flow diagram showing user interaction with an AI profile management system, consistent with an example embodiment. At 202, a user initiates a session with the AI profile management system, which in this example is named QRME. The user may initiate the session by visiting a website such as by entering a URL in a web browser, or by downloading and executing an app such as on a smart phone or tablet.

The process determines whether the user is a new user at 204, and if the user is new, proceeds with a registration process shown at 206-214. The registration process starts at 206 with verification of the user's age and consent to the terms of use of the AI profile management system, and if the user is too young to consent to the terms, allows a parent or guardian to consent on the minor's behalf. The user may be asked to provide various demographic information for themselves at 208, and may be asked to provide demographic information for the AI profile to be synthesized and/or managed. The user may also choose a profile user name, and may elect to make the AI profile anonymous or linked to their account, private or public, and make other such profile elections. User verification at 206 and/or 208 may include verification of the user's email address, such as by asking the user to enter their email address and sending a verification email to the user's provided address. The email contains a link that the user can click to verify that they are the owners of the email address, such as by reporting back to the AI profile management system 102 that the user has clicked the unique link provided to them and associated with verifying the email address associated with their profile.

The user may configure a synthetic AI profile to function in a certain way, such as setting social media permissions for the AI profile to read, post, and perform other such actions on one or more social media platforms at 210. The user may further configure privacy settings, control what kinds of media or content the AI profile may generate, and set profile parameters such as whether the profile ages and grows more mature with age or time at 212. Profile interactions may be further tailored at 214, such as by specifying how the AI profile may interact with others. Examples of such configurable interaction include determining whether the AI profile will create its own content spontaneously or react to direct queries, prompts, or other content published by other users. The AI profile's interactions may vary based on factors such as who the AI profile is interacting with, the relationship a user has with the manger of the AI profile, whether the profile represents a private person, a public figure or historic figure, or is completely synthesized and does not represent a real person. A user may also wish to modify an existing AI profile as reflected at 216, such as to change an AI profile's linked social media and permissions, demographic information, scope of interaction with others, or other such parameters.

In the example of FIG. 2, users may interact with the AI profile at 218 once the AI profile has been created and/or any desired management or configuration actions have been taken. The user may interact with a social media profile by posting content, commenting on content the AI profile has posted, or by otherwise engaging with the AI profile in ways similar to how the user would engage with real people. The AI profile may represent the user, or a part of the user, either anonymously or with the managing user's identity publicly available, and act as a version of the user autonomously on social media. An AI profile representing the profile manager or user may be subject to certain constraints, such as approval of posts or other content before they are made visible to the public. AI profiles in further examples may be specially denoted as AI profiles, such that users can distinguish AI profiles and associated content from real people and their associated content. In some examples, AI profiles may be configured to only interact with the managing user, such as where a user wishes to converse with a public figure, a lost relative, or a version of themselves such as a version of themselves configured to have greater maturity and confidence. In another such example, a user may wish to create an AI profile for conversation, exchange of images and other such content, and the like, of an adult nature. Such an AI profile may be user-configurable as with other AI profile examples presented herein, and in some examples may be adaptive or learn based on responses received from the user managing or employing the AI profile, such as to improve user engagement with the AI profile.

The AI profile may be configured to interact with others at 220, reading content, responses, media, and the like created by others including in response to content created by the AI profile. The AI profile may use such responsive content as a prompt, facilitating further response or content creation via the AI profile such as by using a large language model such as a generative pretrained transformer, recurrent neural network, or other such technology. Content generated by the AI profile may be moderated for distribution at 222, such as to ensure it complies with community guidelines or terms of use, and is acceptable to the AI profile manager prior to distribution. The content may then be published to others' news feeds, included in instant messages or chats, or otherwise made available to additional users or to the public.

The AI profile instance may be updated with knowledge of social media interactions, responses to AI profile-generated content, and the like, facilitating creation of more responsive and more engaging content from the AI profile. In one such example, a generative pretrained transformer such as OpenAI's ChatGPT, Grok, DeepSeek, or the like may be employed and trained with or otherwise configured to retain knowledge of past interactions with one or more users.

In another example, other inputs, such as Google Glasses captured data such as video and/or audio, smart watch captured data, smartphone captured data, or the like may be employed to train the synthetic AI profile on interacting with or relating to a particular user, on making the synthetic AI profile more representative of a real person, or for other such training purposes.

The example of FIG. 2 illustrates how a synthetic AI profile management system such as that shown in FIG. 1 can provide a user with an environment in which they can interact with a synthetic or artificial intelligence-based version of themselves, another person, or a synthesized person. Use of AI technology such as a large language model or generative pretrained transformer tools may engage with the user in a conversational manner, providing entertainment, guidance, counseling, knowledge, training, or meet other needs of a user or AI profile manager.

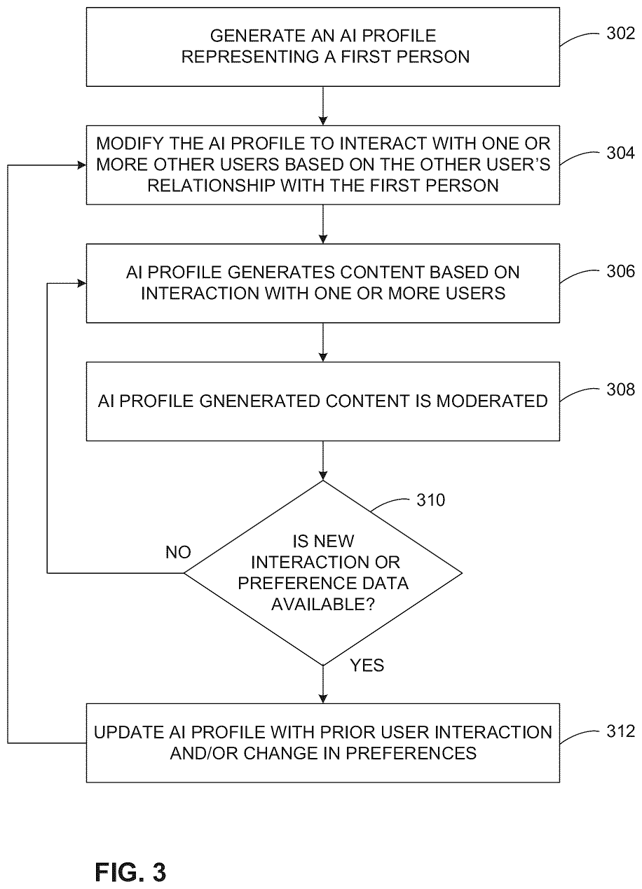

FIG. 3 is a flow diagram of a method of interacting with an artificial intelligence (AI) profile, consistent with an example embodiment. At 302, an AI profile management system such as that of the examples in FIGS. 1 and 2 receives a request to generate a new AI profile. The new profile in various examples may represent the user or certain portions or aspects of the user, may represent another person such as a loved one, a celebrity, or a historic figure, or may represent a synthesized person. In further examples, the AI profile may represent a combination of aspects or characteristics several people, such as a combination of several past presidents or business leaders, a combination of trusted relatives such as grandparents who are gone, or other such hybrid profiles.

The generated profile may be modified or customized at 304 to interact with the AI profile manager or other user, such as based on the user's relationship with the AI profile. For example, if the AI profile is a deceased grandfather of the AI profile manager, the AI profile may be configured to refer to the AI profile manager using a pet name, as a grandson, using terms and phrases the grandfather was known to use when communicating with his grandkids, or the like. Other modifications may be available in various examples, such as varying the AI profile's race, language, culture, ethnic background, age and/or maturity, and other such characteristics. The user may further wish to be able to control or modify aspects of the AI profile's personality, such as mood, outlook, maturity, agreeableness, confidence, curiosity, and the like.

Once the AI profile is constructed and any desired modifications have been made, the user may interact with the AI profile at 306, such as by receiving and responding to content generated by the AI profile, including social media posts, voice chat, instant message or other messaging or email, video chat, pictures, and the like. The user may engage in back-and forth exchange of such content with the AI profile, which in a further example may function as prompts for the AI profile's large language model. The AI profile may grow to learn various things about one or more users during such interactions, improving the AI profile's understanding of one or more users and how to interact with them.

AI generated content may be moderated at 208, such as to verify that the content complies with terms of service or community standards, and to ensure that content that may be made public is consistent with the wishes of the AI profile manager. As new AI profile content is created and responses from users are compiled, the AI profile management system may learn more about one or more users by determining whether new interaction or preference data is available at 310, and updating the AI profile with prior user interactions and/or changes in user preferences at 312 before continuing user interactions. The AI profile may therefore learn more about one or more different users over time through interaction, and improve user engagement and apparent intelligence or knowledge for future interactions with the one or more users.

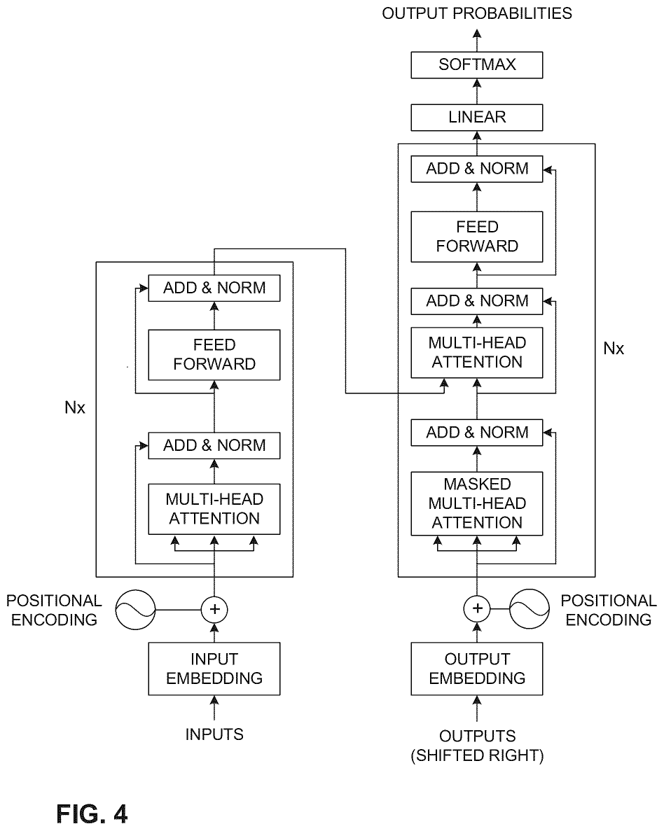

Some elements of the AI profile management system, such as the large language model-based AI profiles provided in examples presented herein, may employ a generative pretrained transformer or similar technology to facilitate automated conversational interaction with a user. One example generative pretrained transformer is ChatGPT, which is shown in the block diagram of FIG. 4, but in other examples other generative pretrained transformers, recurrent neural networks, or other such technologies such as Microsoft Copilot, Google Bard, Amazon Q, Grok, or DeepSeek may be employed. The inputs here comprise a series of words that are preprocessed (e.g. converted to numbers or other input vectors) and provided in sequence to generate output probabilities of the next word. Once the next word is obtained, it may be added to the input so that the subsequent word may be obtained, causing the ChatGPT system to repeatedly predict the next word in a response to a prompt. In a more sophisticated example, the input sequence is fixed at some value, such as 2048 words, and the extra positions at the beginning are padded with zeros. The output is similarly an array of possible outcomes with associated probabilities, such that the most probable next word may be selected as the next word in the response or output.

Because input vectors in this example indicate only a single word and comprise many more zeros than ones (e.g., ChatGPT has a vocabulary of over 50,000 input words and associated vectors), the input is embedded or encoded into a smaller multidimensional space at the input embedding element. The position of each resulting token in a sequence of inputs is encoded and provided to multi-head attention element operable to predict the degree to which each input token is likely to impact the output. The feed-forward block is a multi-layer neural network, operable to learn over time to predict the next word in a sequence. Add & norm blocks take the output of a feed-forward network block and add it to its output, which is normalized before being output. Implementation of large language models, generative pretrained transformers, and similar artificial intelligence is significantly more complex that the basic blocks described here, and any such iteration, variation, or improvement on such technology may be used in various embodiments.

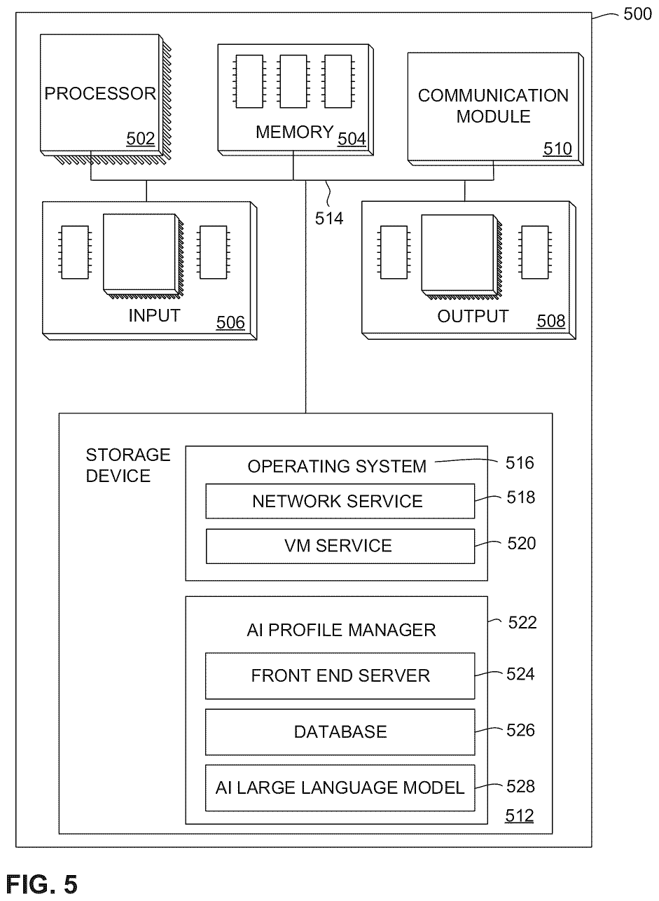

FIG. 5 shows a block diagram of a general-purpose computerized system, consistent with an example embodiment. FIG. 5 illustrates only one particular example of computing device 500, and other computing devices 500 may be used in other embodiments. Although computing device 500 is shown as a standalone computing device, computing device 500 may be any component or system that includes one or more processors or another suitable computing environment for executing software instructions in other examples, and need not include all of the elements shown here.

As shown in the specific example of FIG. 5, computing device 500 includes one or more processors 502, memory 504, one or more input devices 506, one or more output devices 508, one or more communication modules 510, and one or more storage devices 512. Computing device 500, in one example, further includes an operating system 516 executable by computing device 500. The operating system includes in various examples services such as a network service 518 and a virtual machine service 520 such as a virtual server. One or more applications, such as AI profile manager 522 are also stored on storage device 512, and are executable by computing device 500.

Each of components 502, 504, 506, 508, 510, and 512 may be interconnected (physically, communicatively, and/or operatively) for inter-component communications, such as via one or more communications channels 514. In some examples, communication channels 514 include a system bus, network connection, inter-processor communication network, or any other channel for communicating data. Applications such as AI profile manager 522 and operating system 516 may also communicate information with one another as well as with other components in computing device 500.

Processors 502, in one example, are configured to implement functionality and/or process instructions for execution within computing device 500. For example, processors 502 may be capable of processing instructions stored in storage device 512 or memory 504. Examples of processors 502 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 512 may be configured to store information within computing device 500 during operation. Storage device 512, in some examples, is known as a computer-readable storage medium. In some examples, storage device 512 comprises temporary memory, meaning that a primary purpose of storage device 512 is not long-term storage. Storage device 512 in some examples is a volatile memory, meaning that storage device 512 does not maintain stored contents when computing device 500 is turned off. In other examples, data is loaded from storage device 512 into memory 504 during operation. Examples of volatile memories include random access memories (RAM), dynamic random access memories (DRAM), static random access memories (SRAM), and other forms of volatile memories known in the art. In some examples, storage device 512 is used to store program instructions for execution by processors 502. Storage device 512 and memory 504, in various examples, are used by software or applications running on computing device 500 such as AI profile manager 522 to temporarily store information during program execution.

Storage device 512, in some examples, includes one or more computer-readable storage media that may be configured to store larger amounts of information than volatile memory. Storage device 512 may further be configured for long-term storage of information. In some examples, storage devices 512 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 500, in some examples, also includes one or more communication modules 510. Computing device 500 in one example uses communication module 610 to communicate with external devices via one or more networks, such as one or more wireless networks. Communication module 510 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 500 uses communication module 510 to wirelessly communicate with an external device such as via a public network.

Computing device 500 also includes in one example one or more input devices 506. Input device 506, in some examples, is configured to receive input from a user through tactile, audio, or video input. Examples of input device 506 include a touchscreen display, a mouse, a keyboard, a voice responsive system, video camera, microphone or any other type of device for detecting input from a user.

One or more output devices 508 may also be included in computing device 500. Output device 508, in some examples, is configured to provide output to a user using tactile, audio, or video stimuli. Output device 508, in one example, includes a display, a sound card, a video graphics adapter card, or any other type of device for converting a signal into an appropriate form understandable to humans or machines. Additional examples of output device 1008 include a speaker, a light-emitting diode (LED) display, a liquid crystal display (LCD or OLED), or any other type of device that can generate output to a user.

Computing device 500 may include operating system 516. Operating system 516, in some examples, controls the operation of components of computing device 500, and provides an interface from various applications such as AI profile manager 522 to components of computing device 500. For example, operating system 516, in one example, facilitates the communication of various applications such as AI profile manager 522 with processors 502, communication unit 510, storage device 512, input device 506, and output device 508. Applications such as AI profile manager 522 may include program instructions and/or data that are executable by computing device 500, such as front end server 524, database 526, and AI large language module 528. These and other program instructions or modules may include instructions that cause computing device 500 to perform one or more of the other operations and actions described in the examples presented herein.

Features of example computing devices employed in example embodiments may comprise features, for example, of a client computing device and/or a server computing device. The term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 1 and in the text associated with the foregoing figure(s) of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example.

Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Various example embodiments are further described in the following numbered clauses:

Clause 1: A method comprising: generating an artificial intelligence (AI) profile representing a first person; modifying the artificial intelligence profile to interact with one or more other users based on the other user's relationship with the first person; and maintaining the artificial intelligence profile representing the first person based on their interaction with the one or more other users. The artificial intelligence profile may perform real-time simulations of the first person's actions, workflows, and decision-making processes for predictive modeling and operational insights. The artificial intelligence profile may be synchronized across devices and platforms, including augmented reality (AR), Google glasses, virtual reality (VR), robotics, and IoT networks, ensuring consistent functionality and representation. The profile may dynamically adapt to environmental data, such as location, conditions, and user behavior, enabling contextual relevance and optimal task performance.

Clause 2: The method of clause 1, wherein modifying the artificial intelligence profile to interact with one or more other users based on the other user's relationship with the first person comprises adapting the artificial intelligence profile based on one or more other user's prompts. The adaptation may extend to role-specific contexts, allowing the AI profile to function as an advisor, collaborator, or operator based on the user's interaction. The AI profile may autonomously interpret user prompts to provide situationally relevant responses, enhancing functionality in professional and personal environments.

Clause 3: The method of clause 2, wherein the graphical image is a moving or video image. The graphical image may dynamically update based on interaction history, user-defined parameters, and contextual changes, supporting immersive experiences in AR, VR, Google Glasses, and holographic systems. Graphical outputs may be embedded with unique watermarking and labeling to distinguish them as AI-generated representations of the persons or objects and any digital constructs.

Clause 4: The method of clause 1, wherein the artificial intelligence (AI) profile is anonymous to the one or more other users. Anonymous profiles may be configured to securely perform task-specific functions while maintaining separation from the real individual. The system may offer and ensures anonymity during multi-user interactions while preserving operational integrity.

Clause 5: The method of clause 1, wherein maintaining the artificial intelligence profile comprises remembering past interactions with the one or more users. Memory modules may include task histories, user preferences, and operational logs to enhance the profile's adaptability and decision-making capabilities. The retained memory may be utilized for predictive modeling, optimizing future interactions, and providing task continuity.

Clause 6: The method of clause 1, wherein maintaining the artificial intelligence profile comprises remembering the degree of engagement or interest shown by the one or more other users to the artificial intelligence profile's interactions. Engagement metrics may be analyzed and stored to adapt the AI profile's future interactions, enhancing user satisfaction and task relevance. The system may leverage engagement data for iterative improvements in workflow efficiency and personalization.

Clause 7: The method of clause 1, further comprising adjusting the artificial intelligence profile's interaction with the one or more users based on a change in the one or more user's age, maturity, interests, mood, or life events. Adjustments may include real-time environmental adaptation, enabling the profile to respond dynamically to changes in user behavior, location, and context. The AI profile may autonomously modify its role and functionality to align with evolving user needs, supporting long-term engagement.

Clause 8: The method of clause 1, further comprising moderating or selectively approving the artificial intelligence profile's interaction with the one or more users based on compliance with community standards and/or terms of service. Moderation may extend to ethical and regulatory compliance for operational outputs, ensuring alignment with industry-specific guidelines. The system may autonomously flag and prevent interactions that violate predefined standards, enhancing trust and security.

Clause 9: The method of clause 1, wherein the artificial intelligence profile interaction with the one or more users comprises social media interaction. Social media interactions may include real-time content generation, audience engagement, and analytics tailored to user-defined objectives. The AI profile may manage cross-platform consistency and branding, ensuring its representation is aligned with user preferences.

Clause 10: The method of clause 1, wherein the artificial intelligence profile comprises a generative pretrained transformer. The generative pretrained transformer may facilitate task delegation, predictive modeling, and workflow management. The system may use the transformer for dynamic learning, enabling continuous optimization of the profile's functionality.

Claim 11: A method comprising: generating an artificial intelligence (AI) profile representing a synthesized person based on a second person's preferences; modifying the artificial intelligence profile to improve engagement with the second person based on the second person's interaction with the synthesized person's artificial intelligence profile; and maintaining the artificial intelligence profile representing the synthesized person to remember past interaction with the second person between sessions of interaction. The synthesized AI profile may incorporate real-time simulation capabilities to mirror interactions and preferences, optimizing engagement based on dynamic user input. The AI profile may leverage predictive analytics to anticipate future interactions, ensuring continuity and personalization across multiple sessions.

Clause 12: The method of clause 11, wherein modifying the artificial intelligence profile to improve engagement with the second person based on the second person's interaction with the synthesized person's artificial intelligence profile comprises adapting the synthesized person's artificial intelligence profile based on one or more second person's prompts. Adaptations may extend to role-specific engagements, enabling the synthesized AI profile to function effectively in personal, educational, or professional settings. The system may dynamically interpret prompts to refine the profile's functionality and enhance contextual responsiveness.

Clause 13: The method of clause 12, wherein the graphical image is a moving or video image. Graphical outputs may include real-time updates that reflect interaction history, contextual adjustments, and user-defined preferences. The visual representations may be compatible with AR, VR, Google glasses and holographic interfaces, enhancing immersive user experiences.

Clause 14: The method of clause 11, further comprising presenting the artificial intelligence profile's synthesized person for interaction with the second person. The presentation may include integration with cross-platform systems, allowing seamless interaction in virtual, augmented, and physical environments. The AI profile may autonomously adjust its presentation based on the second person's preferences and contextual needs.

Clause 15: The method of clause 14, wherein the synthesized person's interaction with the second person is of an adult nature. Interactions involving adult content may adhere to strict moderation and ethical guidelines, ensuring compliance with community standards and regulations. The system may include dynamic consent protocols, verifying engagement permissions before initiating such interactions.

Clause 16: The method of clause 11, wherein maintaining the artificial intelligence profile comprises remembering past interactions with the one or more users. The memory module may retain detailed interaction logs, user preferences, and feedback to improve engagement and relevance over time. The AI profile may use stored memories to refine its predictive modeling and enhance user-specific outputs.

Clause 17: The method of clause 11, further comprising adjusting the artificial intelligence profile's interaction with the one or more users based on a change in the one or more user's age, maturity, interests, mood, or life events. Adjustments may include real-time behavioral analysis, enabling the profile to respond dynamically to changes in user circumstances. The AI profile may autonomously modify its role and tone to maintain alignment with evolving user expectations and preferences.

Clause 18: The method of clause 11, further comprising moderating or selectively approving the artificial intelligence profile's interaction with the one or more users based on compliance with community standards and/or terms of service. Moderation mechanisms may be embedded to ensure interactions align with ethical standards, privacy laws, and user-defined boundaries. The system may autonomously flag and adjust inappropriate interactions, maintaining trust and compliance across all user engagements.

Clause 19: The method of claim 11, wherein the artificial intelligence profile comprises a generative pretrained transformer operable to provide the artificial intelligence (AI) profile with contextual understanding such that the artificial intelligence (AI) profile may provide a relevant response to a variety of inputs. The generative pretrained transformer may enable dynamic adaptation, real-time learning, and multi-tasking capabilities tailored to user-specific needs. The system may leverage the transformer to enhance the AI profile's contextual understanding, ensuring relevance in diverse scenarios.

Clause 20: A computing system, comprising: an artificial intelligence (AI) profile embodied in machine-readable data, the artificial intelligence profile representing a synthesized person based on a second person's preferences; and an artificial intelligence profile training module operable to modify the artificial intelligence profile to improve engagement with the second person based on the second person's interaction with the synthesized person's artificial intelligence profile; wherein the artificial intelligence profile representing the synthesized person is maintained to remember past interaction with the second person between sessions of interaction. The computing system may include cross-platform compatibility, enabling the AI profile to operate seamlessly across Bluetooth devices, AR, VR, IoT, and robotic systems. The training module may incorporate predictive modeling and environmental adaptation to refine engagement strategies and task execution in real-time. The system may embed unique watermarks in outputs to ensure traceability and distinguish AI-generated interactions from unauthorized duplicates.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

What is claimed is:

1. A method comprising:
generating an artificial intelligence (AI) profile representing a first person;
modifying the artificial intelligence profile to interact with one or more other users based on the other user's relationship with the first person; and
maintaining the artificial intelligence profile representing the first person based on their interaction with the one or more other users.

2. The method of claim 1, wherein modifying the artificial intelligence profile to interact with one or more other users based on the other user's relationship with the first person comprises adapting the artificial intelligence profile based on one or more other user's prompts.

3. The method of claim 2, wherein the graphical image is a moving or video image.

4. The method of claim 1, wherein the artificial intelligence (AI) profile is anonymous to the one or more other users.

5. The method of claim 1, wherein maintaining the artificial intelligence profile comprises remembering past interactions with the one or more users.

6. The method of claim 1, wherein maintaining the artificial intelligence profile comprises remembering the degree of engagement or interest shown by the one or more other users to the artificial intelligence profile's interactions.

7. The method of claim 1, further comprising adjusting the artificial intelligence profile's interaction with the one or more users based on a change in the one or more user's age, maturity, interests, mood, or life events.

8. The method of claim 1, further comprising moderating or selectively approving the artificial intelligence profile's interaction with the one or more users based on compliance with community standards and/or terms of service.

9. The method of claim 1, wherein the artificial intelligence profile interaction with the one or more users comprises social media interaction.

10. The method of claim 1, wherein the artificial intelligence profile comprises a generative pretrained transformer.

11. A method comprising:
generating an artificial intelligence (AI) profile representing a synthesized person based on a second person's preferences;
modifying the artificial intelligence profile to improve engagement with the second person based on the second person's interaction with the synthesized person's artificial intelligence profile; and
maintaining the artificial intelligence profile representing the synthesized person to remember past interaction with the second person between sessions of interaction.

12. The method of claim 11, wherein modifying the artificial intelligence profile to improve engagement with the second person based on the second person's interaction with the synthesized person's artificial intelligence profile comprises adapting the synthesized person's artificial intelligence profile based on one or more second person's prompts.

13. The method of claim 12, wherein the graphical image is a moving or video image.

14. The method of claim 11, further comprising presenting the artificial intelligence profile's synthesized person for interaction with the second person.

15. The method of claim 14, wherein the synthesized person's interaction with the second person is of an adult nature.

16. The method of claim 11, wherein maintaining the artificial intelligence profile comprises remembering past interactions with the one or more users.

17. The method of claim 11, further comprising adjusting the artificial intelligence profile's interaction with the one or more users based on a change in the one or more user's age, maturity, interests, mood, or life events.

18. The method of claim 11, further comprising moderating or selectively approving the artificial intelligence profile's interaction with the one or more users based on compliance with community standards and/or terms of service.

19. The method of claim 11, wherein the artificial intelligence profile comprises a generative pretrained transformer operable to provide the artificial intelligence (AI) profile with contextual understanding such that the artificial intelligence (AI) profile may provide a relevant response to a variety of inputs.

20. A computing system, comprising:
an artificial intelligence (AI) profile embodied in machine-readable data, the artificial intelligence profile representing a synthesized person based on a second person's preferences; and
an artificial intelligence profile training module operable to modify the artificial intelligence profile to improve engagement with the second person based on the second person's interaction with the synthesized person's artificial intelligence profile;
wherein the artificial intelligence profile representing the synthesized person is maintained to remember past interaction with the second person between sessions of interaction.
